(19) United States
(12) Patent Application Publication
(10) Pub. No.: US 2012/0091916 A1
(43) Pub. Date: Apr. 19, 2012

(54) RADIATION SOURCE

(75) Inventors: Mykhaylo SEMTSIV, Berlin (DE); William Masselink, Berlin (DE)

(73) Assignee: HUMBOLDT-UNIVERSITAT ZU BERLIN

(21) Appl. No.: 12/905,049

(22) Filed: Oct. 14, 2010

(51) Int. Cl. H05B 37/00

(52) U.S. Cl. 315/312

(57) ABSTRACT

An embodiment of the invention relates to a cascade semiconductor light source comprising:

a first block of cascades and a first contact region coupled to said first cascade, the first contact region being capable of injecting carriers into the first cascade of the first block; and

a second block of cascades and a second contact region coupled to said second cascade, the second contact region being capable of injecting carriers into the second cascade;

wherein the application of a first polarity voltage to said light source results in the cascades in the first block to be in an active mode and the cascades in the second block to be in an inactive mode;

wherein the application of a second, opposite polarity voltage to said light source results in the cascades in the first block to be in an inactive mode and the cascades in the second block to be in an active mode;

wherein the first block of cascades is adapted to emit light at a first wavelength in its active mode and to passively conduct electrical current in its inactive mode; and wherein the second block of cascades is adapted to emit light at a second wavelength in its active mode and to passively conduct electrical current in its inactive mode.

The invention relates to cascade semiconductor radiation (light) sources. Hereinafter, the term “light” refers to any sort of electromagnetic radiation of any wavelength, whether visible or not.

### BACKGROUND OF THE INVENTION

Multi-wavelength Quantum Cascade Lasers (QCLs) have recently attracted quite some attention [1-7] in the QCL community. For instance, in U.S. Pat. No. 6,278,134 Capasso (Ref. 1) describes a bi-directional semiconductor light source that provides emission in response to either a positive or negative bias voltage. With an asymmetric injector region in the cascade structure, the device will emit at a first wavelength under a negative bias and a second wavelength under a positive bias. This asymmetric injector must be designed to work as an injector in both bias directions, necessitating design compromises that complicate performance optimization.

### OBJECTIVE OF THE PRESENT INVENTION

An objective of the present invention is to provide a cascade semiconductor light source that assumes a high performance for at least two different wavelengths that are selected by the bias polarity.

A further objective of the present invention is to provide a cascade semiconductor light source structure which allows optimizing the emission characteristics for at least two different wavelengths without the dual-use injector region of Ref. 1.

### BRIEF SUMMARY OF THE INVENTION

An embodiment of the present invention relates to a cascade semiconductor light source comprising:

at least one cascade of a first type and a first contact region coupled to said first cascade, the first contact region being capable of injecting carriers into the first cascade; and at least one cascade of a second type and a second contact region coupled to said second cascade, the second contact region being capable of injecting carriers into the second cascade;

wherein the application of a first polarity voltage to said light source results in any cascade of the first type to be in an active mode and any cascade of the second type to be in an inactive mode;

wherein the application of a second, opposite polarity voltage to said light source results in any cascade of the first type to be in an inactive mode and any cascade of the second type to be in an active mode;

wherein any cascade of the first type is adapted to emit light at a first wave-length in its active mode and to passively conduct electrical current in its inactive mode; and

wherein any cascade of the second type is adapted to emit light at a second wavelength in its active mode and to passively conduct electrical current in its inactive mode.

A cascade may be or comprise a region containing multiple layers of different semiconductors (e.g. multi heterostructure) designed so that when biased a certain way, a higher-energy state (upper laser state) becomes populated with charge carriers, an intersubband transition can take place in which the charge carriers make a transition from the upper laser state to a state with lower energy (lower laser state), resulting in the emission of light, and the lower laser state is depopulated of the charge carriers, that are then transferred into the next (“neighbor”) cascade.

A contact region may be or comprise a region supplying or removing electrons to or from their adjacent cascades.

According to a preferred embodiment a transfer region may be disposed between a first block comprised of cascades of the first type connected to each other in series and a second block comprised of cascades of the second type. When the device is positively biased, the first type of cascade is active and when the device is negatively biased, the second type of cascade is active. A transfer region may be a region that removes the electrons from the last cascade of the block of active cascades and supplies it to the first cascade of the adjacent inactive block in a way to reduce the resistance of the inactive block. The transfer region is adapted to conduct electrical current in any polarity.

There may be more than 1 block of each type of cascade and each block may be comprised of any number of cascades including one.

In order to provide efficient radiation the cascades of the first and/or second types are preferably adapted to emit light via intersubband transitions of electrons during their active mode.

An advantage of the invention compared to Ref. 1 is that the first type of cascade and the second type of cascade may be independently optimized as both cascade regions including their respective injectors are distinct from the other type of cascade with its injector. As such, for example, the emitting wavelengths of the first and second cascades may be individually engineered.

Further, due to the independent optimization of the cascades even room-temperature operation may be achieved for both wavelengths.

According to a preferred embodiment, the transfer region may be adapted to boost the conductivity of the cascades of the first and/or second type during their inactive mode. As such, the voltage drop over the region that is in inactive mode, and thus the generation of heat may be reduced.

The transfer region is preferably adapted to boost the conductivity of the cascades of the first and/or second types by transferring carriers into the quasicontinuum of states largely derived from the materials' F-point of the conduction band of the first and/or second cascade types.

Alternatively or additionally, the transfer region may be adapted to boost the conductivity of the cascades of the first and/or second types by transferring carriers into indirect X- and/or L-valleys of the conduction band of the first and/or second cascade types.

The first and second types of cascades may provide that the first and second wavelengths differ from one another.

Alternatively, the first and second types of cascades may be configured to emit light at the same wavelength.

Cascades of the first and second types may each include alternating barrier and quantum well layers in order to increase the efficiency.

The barrier layers of cascades of the first type preferably differ from the barrier layers of cascades of the second type in order to allow individual optimization. Further, the quantum well layers of cascades of the first type may differ from the quantum well layers of cascades of the second type.

Preferably, the barrier and quantum well layers are undoped.

A further embodiment of the present invention relates to a spectroscopy system comprising:

a detector for detecting radiation and for providing a detection signal; an evaluation unit connected to the detector and configured to evaluate the detection signal; and

a cascade semiconductor light source having:

at least one cascade of a first type and a first contact region coupled to said first cascade, the first contact region being capable of injecting carriers into the first cascade; and

at least one cascade of a second type and a second contact region coupled to said second cascade, the second contact region being capable of injecting carriers into the second cascade;

wherein the application of a first polarity voltage to said light source results in any cascade of the first type to be in an active mode and any cascade of the second type to be in an inactive mode;

wherein the application of a second, opposite polarity voltage to said light source results in any cascade of the first type to be in an inactive mode and any cascade of the second type to be in an active mode;

wherein any cascade of the first type is adapted to emit light at a first wavelength in its active mode and to passively conduct electrical current in its inactive mode; and

wherein any cascade of the second type is adapted to emit light at a second wavelength in its active mode and to passively conduct electrical current in its inactive mode.

As discussed above, the wavelength of the light (radiation) emitted by the cascade semiconductor light source may be changed by inverting the voltage polarity. As such, a spectroscopy system comprising such a light source allows detecting several gases and/or several isotopes in a quasi-simultaneous fashion by inverting the voltage polarity, only.

### BRIEF DESCRIPTION OF THE DRAWINGS

In order that the manner in which the above-recited and other advantages of the invention are obtained will be readily understood, a more particular description of the invention briefly described above will be rendered by reference to specific embodiments thereof which are illustrated in the appended figures and tables. Understanding that these figures and tables depict only typical embodiments of the invention and are therefore not to be considered to be limiting of its scope, the invention will be described and explained with additional specificity and detail by the use of the accompanying drawings in which

FIG. 1 shows a first exemplary embodiment of an inventive cascade semiconductor light source under a positive bias voltage;

FIG. 2 shows the first exemplary embodiment under a negative bias voltage;

FIG. 3 shows a second exemplary embodiment of an inventive cascade semiconductor light source under a positive bias voltage;

FIG. 4 shows the second exemplary embodiment under a negative bias voltage;

FIG. 5 shows the electronic band structure of a third embodiment of an inventive cascade semiconductor light source under a positive bias voltage;

FIG. 6 shows the electronic band structure of the third embodiment under a negative bias voltage;

FIG. 7 shows an exemplary embodiment of an inventive spectroscopy system; and

FIGS. 8-9 show a sketch of a further embodiment of the present invention having blockwise ordered emitters of different wavelength.

### DETAILED DESCRIPTION OF PREFERRED EMBODIMENTS

The preferred embodiments of the present invention will be best understood by reference to the drawings, wherein identical or comparable parts are designated by the same reference signs throughout.

It will be readily understood that the present invention, as generally described herein, could vary in a wide range. Thus, the following more detailed description of the exemplary embodiments of the present invention, is not intended to limit the scope of the invention, as claimed, but is merely representative of presently preferred embodiments of the invention.

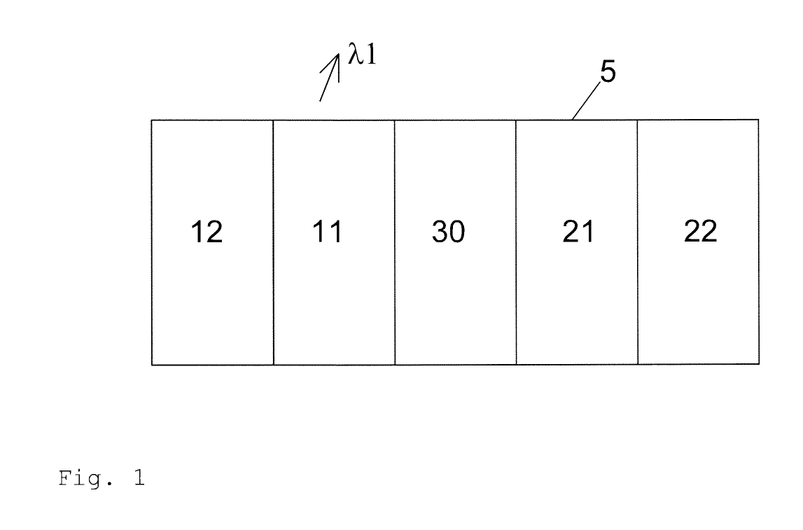

FIG. 1 shows an exemplary embodiment of an inventive cascade semiconductor light source 5.

The light source 5 comprises a first cascade 11 and a first contact region 12 which is coupled to the first cascade 11. The first contact region 12 injects carriers into the first cascade 11 if a positive bias voltage is applied to the light source 5.

The light source 5 further comprises a second cascade 21 and a second contact region 22 coupled to the second cascade 21. The second contact region 22 injects carriers into the second cascade 21 if a negative bias voltage is applied to the light source 5.

The first cascade 11 and the second cascade 21 are separated by a transfer region 30.

When a positive voltage is applied to light source 5, the first cascade 11 is in an active mode and the second cascade 21 is an inactive mode. Then, only the first cascade 11 will emit radiation at a first wavelength λ1. The transfer region 30 extracts charge carriers from the first cascade 11 and boosts the conductivity of the second cascade 21, for instance by transferring carriers into the quasi-continuum of a F-point of the conduction band of the second cascade 21 or by transferring carriers into indirect X- and/or L-valleys of the conduction band of the second cascade 21.

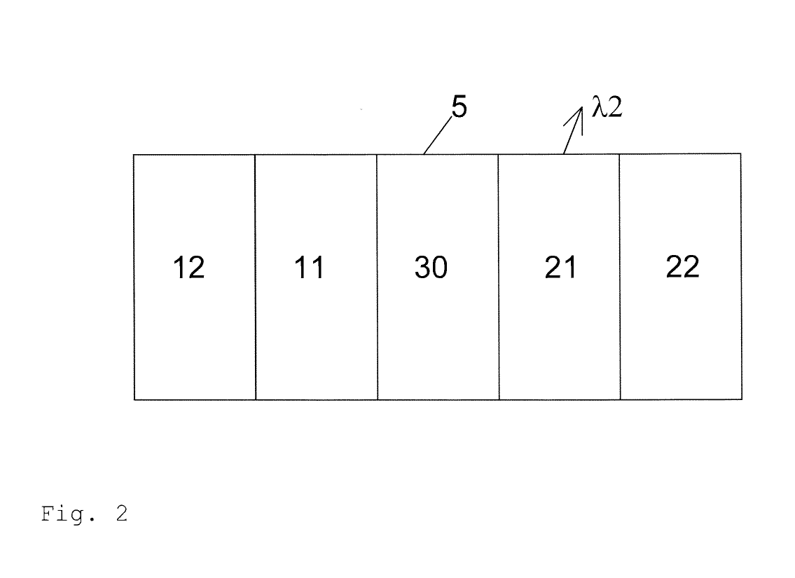

When a negative voltage is applied to light source 5, as shown in FIG. 2, the first cascade 11 is in an inactive mode and the second cascade 21 is in an active mode. Then, only the second cascade 21 will emit radiation at a second wavelength λ2. The transfer region 30 extracts charge carriers from the second cascade 21 and boosts the conductivity of the first cascade 11, for instance by transferring carriers into the quasi-continuum of a F-point of the conduction band of the first cascade 11 or by transferring carriers into indirect X- and/or L-valleys of the conduction band of the first cascade 11.

In the exemplary embodiment of FIG. 1, the light source 5 comprises two cascades 11 and 21, only. Instead, the light source 5 may comprise more cascades. For instance the light source 5 may comprise more “first” cascades, which are active under a positive bias voltage, and/or more “second” regions, which are active under a negative bias voltage.

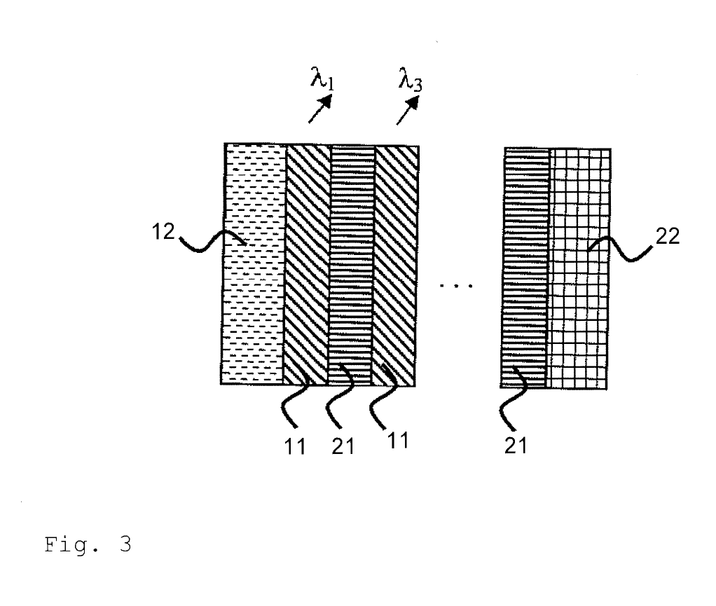

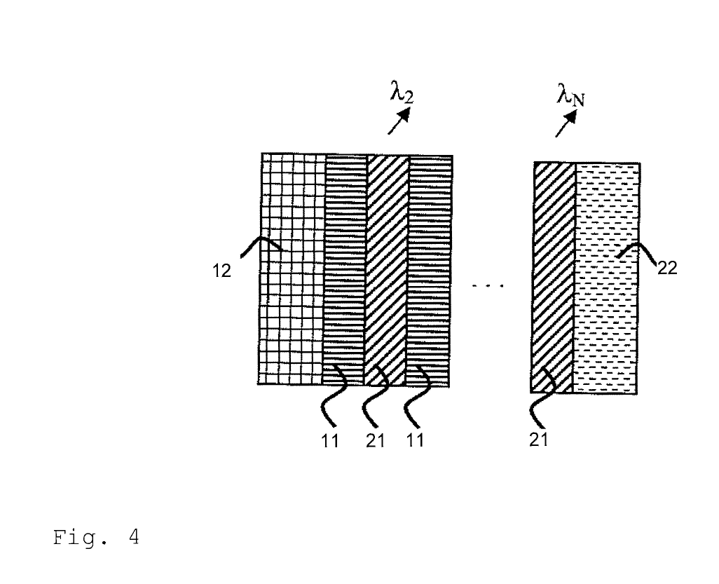

FIG. 3 shows a second exemplary embodiment of an inventive cascade semiconductor light source 5 under a positive bias voltage. The light source 5 comprises a plurality of “first” cascades, which are active under a positive bias voltage (see FIG. 3), and a plurality of “second” cascades 21, which are active under a negative bias voltage (see FIG. 4).

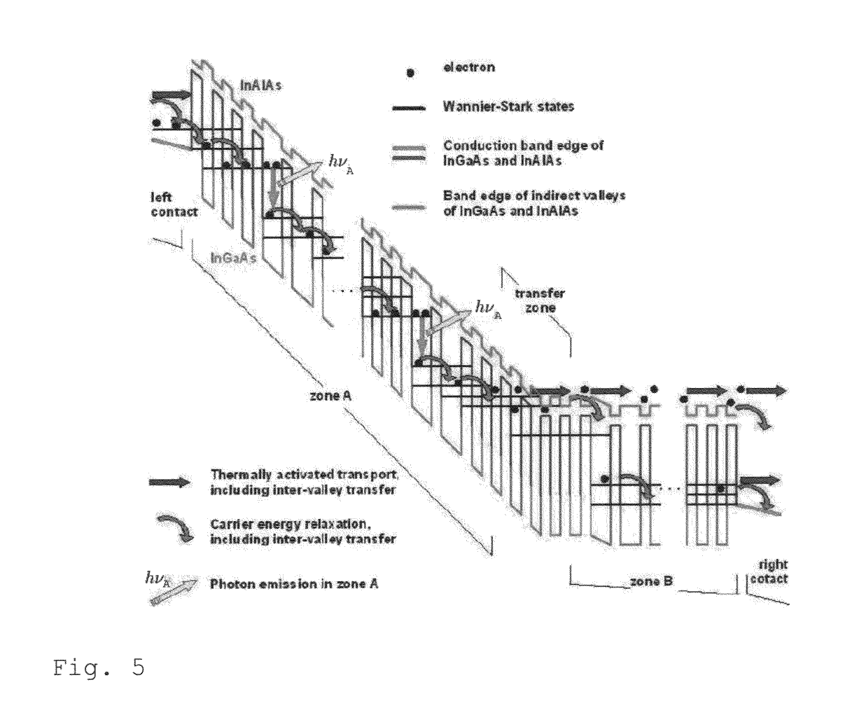

FIG. 5 shows the electronic band structure of a third exemplary embodiment of an inventive cascade semiconductor light source 5 under a positive bias voltage. For a positive electrical bias (right contact is positive), a first emitter zone A, which comprises at least one first cascade and at least one first contact region, emits a wavelength

λ_{A}=c/υ_{A}

via intersubband transitions of electrons.

A second emitter zone B passively conducts electrical current at this bias.

A transfer region referred to as “transfer zone” in FIG. 5, boosts the conductivity of the second emitter zone B by transferring the carriers into the quasicontinuum of a F-point (above the barriers) and/or by transferring the carriers into indirect (X- and L-) valleys of the conduction band. This way, the voltage drop (i.e. the released heat) across the emitter zone B is minimized, which is advantageous for the device performance.

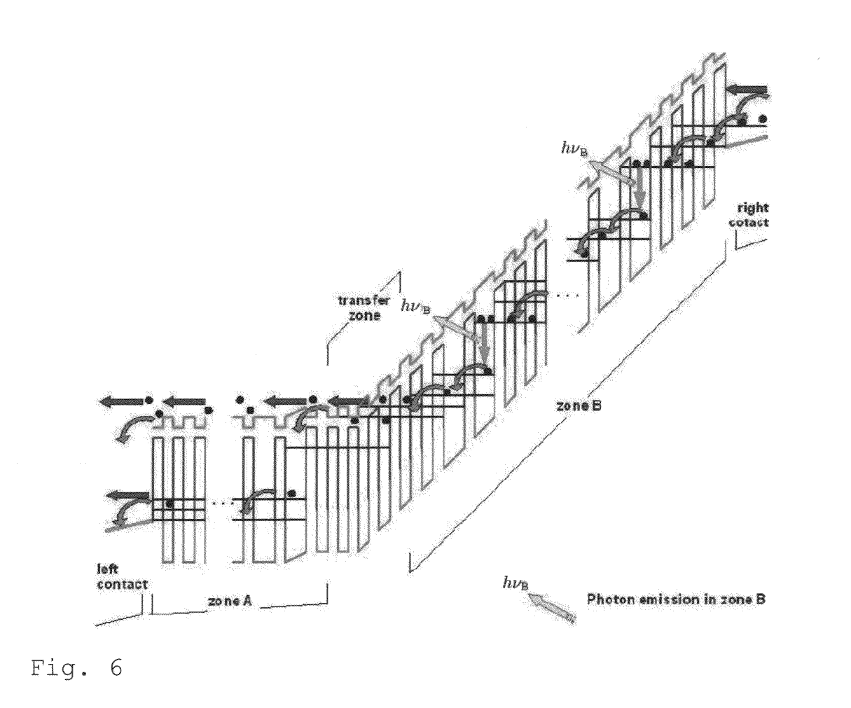

For a negative electrical bias (right contact is negative, FIG. 6), the second emitter zone B emits light at

λ_{B}=c/υ_{B},

and the first emitter zone A passively conducts electrical current. The functionality of the transfer region (transfer zone) (i.e. to boost the conductivity over the passive zone) is the same for both polarities.

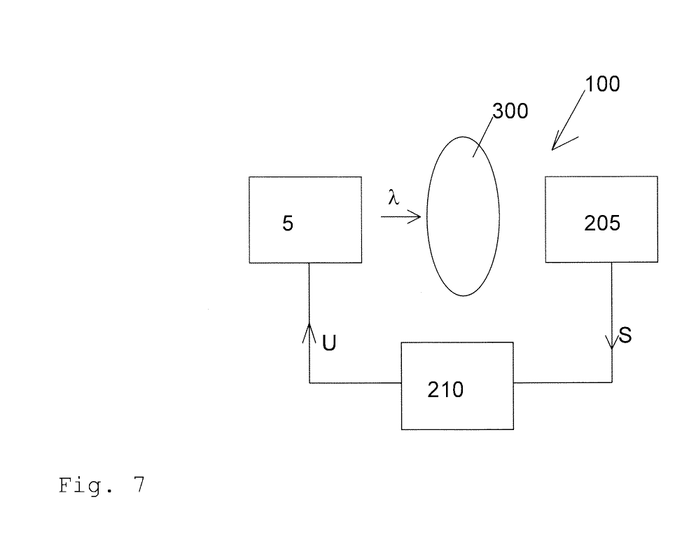

FIG. 7 shows an exemplary embodiment of an inventive spectroscopy system 100. The spectroscopy system 100 comprises a cascade semiconductor light source 5, a detector 205 for detecting radiation and to provide a detection signal S, and an evaluation unit 210.

The evaluation unit 210 is connected to the light source 5 and to the detector 205. The evaluation unit 210 controls the emission of light λ by light source 5 and evaluates the detection signal S. The evaluation unit 210 may invert the polarity of voltage U applied to light source 5 in order to detect gases 300 and/or isotopes 300 in a simultaneous or quasi-simultaneous fashion.

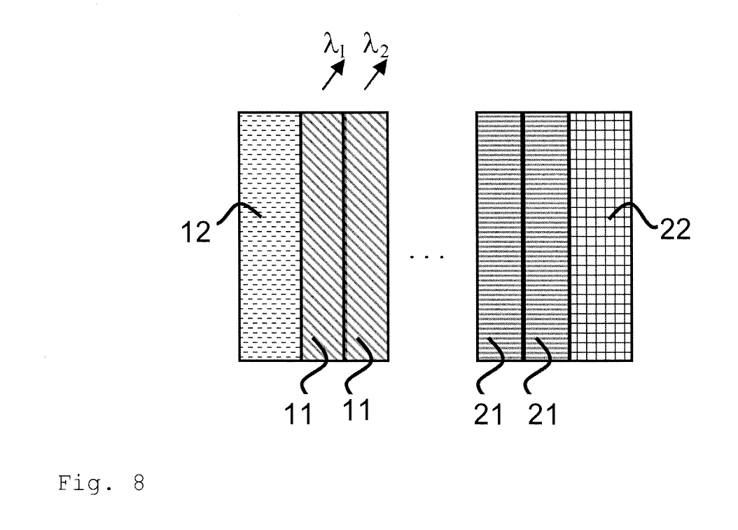

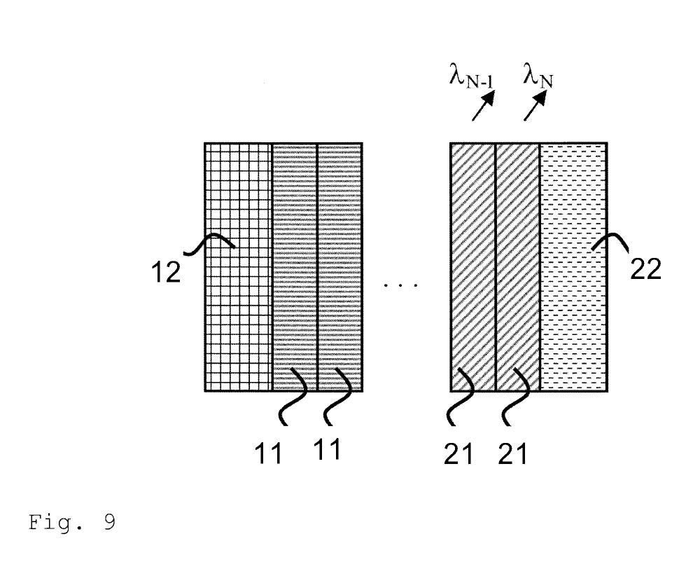

FIG. 8 shows a sketch of a further exemplary embodiment of an inventive cascade semiconductor light source under a positive bias voltage (left contact 12 is negative, and right 22 contact positive). The light source comprises a plurality of “first” cascades 11, which are active under a positive bias voltage (see FIG. 8), and a plurality of “second” cascades 21, which are active under a negative bias voltage (see FIG. 9). The active and inactive cascades are blockwise ordered and emit at different wavelengths.

### REFERENCES

1. F. Capasso et al, “Bi-directional unipolar semiconductor light source”, Patent U.S. Pat. No. 6,278,134 B1 (2001).

2. V. Berger, “Unipolar Multiple-Wavelength Laser”, patent U.S. Pat. No. 6,091,751 (2000).

3. F. Capasso et. al, “Article comprising a dual-wavelength quantum cascade photon source”, patent U.S. Pat. No. 6,144,681 (2000).

4. F. Capasso et. al, “Multiple wavelength quantum cascade light source”, patent U.S. Pat. No. 6,148,012 (2000).

5. F. Capasso et. al, “Engineering the gain/loss profile of intersubband optical devices having heterogeneous cascades”, patent U.S. Pat. No. 6,728,282 (2004).

6. F. Capasso et. al, “Broadband cascade light emitters”, patent U.S. Pat. No. 7,0100,10 (2006)

7. C. Gmachl, A. Tredicucci, D. L. Sivco, A. L. Hutchinson, F. Capasso, and A. Y. Cho, “Bidirectional Semiconductor Laser”, Science 286, 749 (1999).

1. A cascade semiconductor light source comprising:
a first block of cascades and a first contact region coupled to said first cascade, the first contact region being capable of injecting carriers into the first cascade of the first block; and
a second block of cascades and a second contact region coupled to said second cascade, the second contact region being capable of injecting carriers into the second cascade;
wherein the application of a first polarity voltage to said light source results in the cascades in the first block to be in an active mode and the cascades in the second block to be in an inactive mode;
wherein the application of a second, opposite polarity voltage to said light source results in the cascades in the first block to be in an inactive mode and the cascades in the second block to be in an active mode;
wherein the first Nock of cascades is adapted to emit light at a first wavelength in its active mode and to passively conduct electrical current in its inactive mode; and
wherein the second block of cascades is adapted to emit light at a second wavelength in its active mode and to passively conduct electrical current in its inactive mode.

2. The light source as defined in claim 1 wherein there exists more than one instance of the first block and/or more than one instance of the second block.

3. The light source as defined in claim 2 wherein varying instances of block 1 and/or block 2 differ from another, having in common the bias polarity resulting in their being in an active mode.

4. The light source as defined in claim 1 whereby a given block may contain any number of cascades including one.

5. The light source as defined in claim 1 wherein a transfer region is disposed between the first and second blocks of cascades.

6. The light source as defined in claim 5 wherein a transfer region adjoins adjacent cascade blocks.

7. The light source as defined in claim 5 wherein the transfer region is adapted to conduct electrical current in any polarity.

8. The light source as defined in claim 5 wherein said transfer region is adapted to boost the conductivity of the cascades of the first and/or second block by transferring carriers into the quasi-continuum of a F-point of the conduction band of the first cascade of the first and/or second block.

9. The light source as defined in claim 8 wherein said transfer region is adapted to boost the conductivity of the first and/or second cascade by transferring carriers into indirect X- and/or L-valleys of the conduction band of the first and/or second cascade.

10. The light source as defined in claim 1 wherein the first and second types of cascades differ from one another.

11. The light source as defined in claim 1 wherein the first and second types of cascades emit light at different wavelengths.

12. The light source as defined in claim I wherein the first and second types of cascades emit light at the same wavelength.

13. The light source as defined in claim 1 wherein the first and second types cascades each include alternating barrier and quantum well layers.

14. The light source as defined in claim 13 wherein the barrier layers of the first type of cascade differ from the barrier layers of the second type of cascade.

15. The light source as defined in claim 13 wherein the quantum well layers of the first type of cascade differ from the quantum well layers of the second type of cascade.

16. The light source as defined in claim 13 wherein the barrier and quantum well layers are undoped.

17. The light source as defined in claim 1 wherein
a transfer region is disposed between the first and second types of cascades, the transfer region adjoining the first and the second types of cascades and configured to conduct electrical current in any polarity and to boost the conductivity of the first and second types of cascade during their inactive mode.

18. A Spectroscopy system comprising:
a detector for detecting radiation and for providing a detection signal;
an evaluation unit connected to the detector and configured to evaluate the detection signal; and
a cascade semiconductor light source having:
a first block of cascades and a first contact region coupled to said first cascade, the first contact region being capable of injecting carriers into the first cascade of the first block; and
a second block of cascades and a second contact region coupled to said second cascade, the second contact region being capable of injecting carriers into the second cascade;
wherein the application of a first polarity voltage to said light source results in the cascades in the first block to be in an active mode and the cascades in the second block to be in an inactive mode;
wherein the application of a second, opposite polarity voltage to said light source results in the cascades in the first block to be in an inactive mode and the cascades in the second block to be in an active mode;
wherein the first block of cascades is adapted to emit light at a first wavelength in its active mode and to passively conduct electrical current in its inactive mode; and
wherein the second block of cascades is adapted to emit light at a second wavelength in its active mode and to passively conduct electrical current in its inactive mode.
